(19) United States
(12) Patent Application Publication
(10) Pub. No.: US 2026/0110488 A1
(43) Pub. Date: Apr. 23, 2026

(54) SHEET CONVEYING DEVICE AND METHOD FOR ADJUSTING SHEET CONVEYING DEVICE

(71) Applicant: Prime Planet Energy & Solutions, Inc., Tokyo (JP)

(72) Inventors: Masayuki HORI, Himeji-shi (JP); Masateru MIKAMI, Himeji-shi (JP)

(21) Appl. No.: 19/359,690

(22) Filed: Oct. 16, 2025

(30) Foreign Application Priority Data
Oct. 23, 2024 (JP) 2024-186418

(51) Int. Cl. F26B 13/10; F26B 13/12

(52) U.S. Cl. CPC F26B 13/108; F26B 13/12

(57) ABSTRACT

A sheet conveying device includes a first conveying portion at which a band-like sheet including a first surface and a second surface is conveyed with the first surface facing downward, a turn portion that includes a convex surface, is provided at downstream of the first conveying portion in a conveyance direction of the sheet, and turns the sheet along the convex surface with the first surface facing inside, a second conveying portion provided at downstream of the turn portion in the conveyance direction, and an air jet device that includes an air nozzle that is provided at a boundary portion between the first conveying portion and the turn portion and extends in the width direction of the sheet and jets air from the air nozzle. The air nozzle is configured such that a width thereof in the conveyance direction can be adjusted.

### CROSS REFERENCE OF RELATED APPLICATION

This application claims the benefit of priority to Japanese Patent Application No. 2024-186418 filed on Oct. 23, 2024. The entire contents of this application are hereby incorporated herein by reference.

### BACKGROUND OF THE DISCLOSURE

The present disclosure relates to a sheet conveying device and a method for adjusting a sheet conveying device.

For example, Japanese Laid-open Patent Publication No. 2023-003004 discloses a dryer that dries a coating material while conveying a band-like metal foil on which the coating material is applied. In the dryer disclosed in Japanese Laid-open Patent Publication No. 2023-003004, a conveyance path is folded in a vertical direction twice so as to have a three-stage structure. A half-cylindrical air turn bar is provided in a folded portion from a second stage to a third stage. At the air turn bar, the metal foil is conveyed along an outer periphery of the half-cylindrical air turn bar such that a side thereof to which the coating material is applied faces inside. The air turn bar has a wall formed of a mesh and is configured such that air is blown out from the wall. According to Japanese Laid-open Patent Publication No. 2023-003004, the metal foil can be caused to float from the air turn bar by air blown from the air turn bar and can be conveyed with a predetermined gap from the air turn bar maintained. Thus, in the air turn bar, the metal foil can be folded without contacting the air turn bar.

### SUMMARY

In the sheet conveying device disclosed in Japanese Laid-open Patent Publication No. 2023-003004, when the metal foil contacts the air turn bar provided to change a direction of the metal foil, the coating material applied to the metal foil is damaged. Herein, a sheet conveying device configured such that a sheet is even less likely to contact a turn portion that turns the sheet is proposed. Moreover, a method for adjusting a sheet conveying device such that a sheet is less likely to contact a turn portion is proposed.

A sheet conveying device proposed herein includes a first conveying portion at which a band-like sheet including a first surface and a second surface on an opposite side of the first surface is conveyed with the first surface facing downward, a turn portion that includes a convex surface an axial line of which extends in a width direction of the sheet, is provided at downstream of the first conveying portion in a conveyance direction of the sheet, and turns the sheet along the convex surface with the first surface facing inside, a second conveying portion that is provided at downstream of the turn portion in the conveyance direction and at which the sheet is conveyed with the second surface facing downward, and an air jet device that includes an air nozzle that is provided at a boundary portion between the first conveying portion and the turn portion and extends in the width direction of the sheet and jets air from the air nozzle. The air nozzle is configured such that a width thereof in the conveyance direction can be adjusted.

According to the sheet conveying device, a wind volume and a wind speed of air jetted from the air nozzle can be adjusted by adjusting the width of the air nozzle in the conveyance direction of the sheet. The sheet conveying device in which the sheet is even less likely to contact the turn portion can be realized due to adjustment of the wind volume and the wind speed of air jetted from the air nozzle.

A method for adjusting a sheet conveying device disclosed herein is a method for adjusting a sheet conveying device that includes a first conveying portion at which a band-like sheet including a first surface and a second surface on an opposite side of the first surface is conveyed with the first surface facing downward, a turn portion that includes a convex surface an axial line of which extends in a width direction of the sheet, is provided at downstream of the first conveying portion in a conveyance direction of the sheet, and turns the sheet along the convex surface with the first surface facing inside, a second conveying portion that is provided at downstream of the turn portion in the conveyance direction and at which the sheet is conveyed with the second surface facing downward, and an air jet device that includes an air nozzle that is provided at a boundary portion between the first conveying portion and the turn portion and extends in the width direction of the sheet and jets air from the air nozzle. The convex surface includes a small-diameter portion that is opposed to a central portion of the sheet in the width direction, and a pair of large-diameter portions that are arranged at both sides of the small-diameter portion in an axial direction, protrude outward from the small-diameter portion in a radial direction, and support both end portions of the sheet in the width direction. The air nozzle is configured such that a width thereof in the conveyance direction of the sheet can be adjusted. The method for adjusting a sheet conveying device includes measuring a difference in position in the radial direction between the both end portions of the sheet in the width direction supported by the pair of large-diameter portions and the central portion of the sheet in the width direction, and adjusting the width of the air nozzle in the conveyance direction such that the measured difference in position in the radial direction is in a preset range.

According to the method for adjusting a sheet conveying device described above, the width of the air nozzle in the conveyance direction of the sheet is adjusted to adjust the wind volume and the wind speed of air and the difference in position in the radial direction between the both end portions of the sheet in the width direction which are supported by the large-diameter portions and the central portion of the sheet in the width direction is caused to be in a predetermined range. Due to the adjustment described above, a gap between the central portion of the sheet in the width direction and the small-diameter portion can be ensured. As a result, the sheet can be caused to be less likely to contact the turn portion.

### BRIEF DESCRIPTION OF THE DRAWINGS

FIG. 1 is a schematic cross-sectional view of a sheet conveying device.

FIG. 2 is a perspective view of a turn portion.

FIG. 3 is a schematic front view of the turn portion.

FIG. 4 is a block diagram of the sheet conveying device.

FIG. 5 is a flowchart related to control of a width of an air nozzle.

FIG. 6 is a flowchart related to control of a width of the air nozzle and an angle of a straightening plate.

FIG. 7 is a graph illustrating a relationship between a floating amount of an electrode sheet, a tension that is applied to the electrode sheet, and whether there were creases generated in the electrode sheet.

### DETAILED DESCRIPTION OF THE PREFERRED EMBODIMENTS

Preferred embodiments of a sheet conveying device will be described below. Note that, as a matter of course, the preferred embodiments described herein are not intended to be particularly limiting the present invention. The accompanying drawings are schematic and do not necessarily reflect an actual implemented product. In the following description, members/portions that have the same effect are denoted by the same reference sign and the overlapping description will be omitted or simplified as appropriate.

### Configuration of Sheet Conveying Device

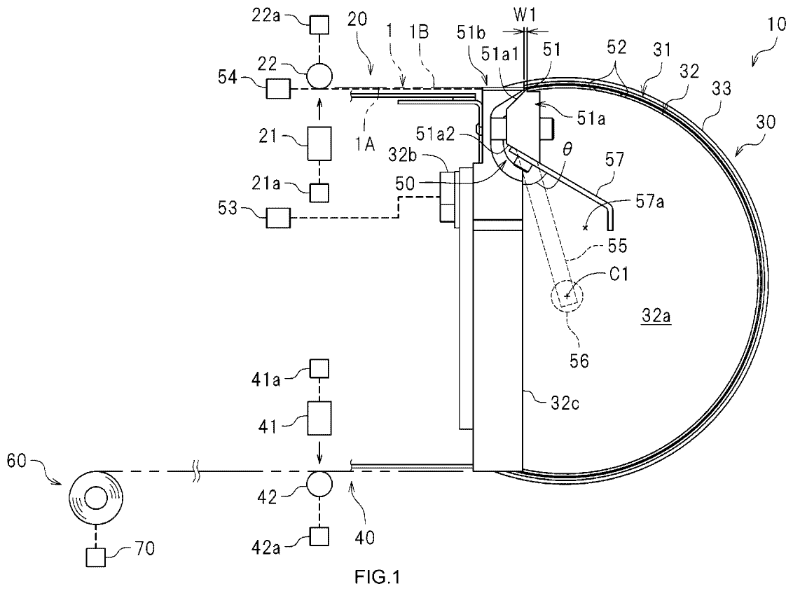

FIG. 1 is a schematic cross-sectional view of a sheet conveying device 10. The sheet conveying device 10 conveys an electrode sheet 1 of an electricity storage device. As used herein, the term “electricity storage device” generally refers to devices from which electric energy can be taken out and expresses a concept encompassing primary batteries and secondary batteries and also encompassing chemical batteries, such as a lithium-ion secondary battery, a nickel hydrogen battery, or the like, and physical batteries, such as an electric double-layered capacitor or the like.

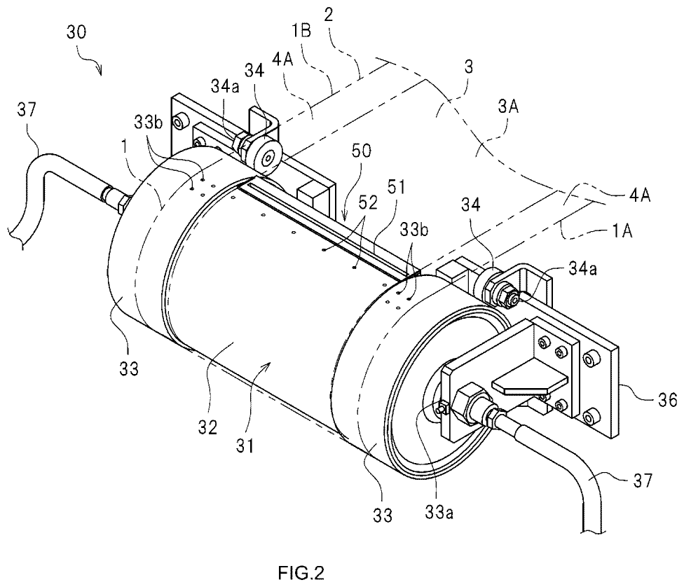

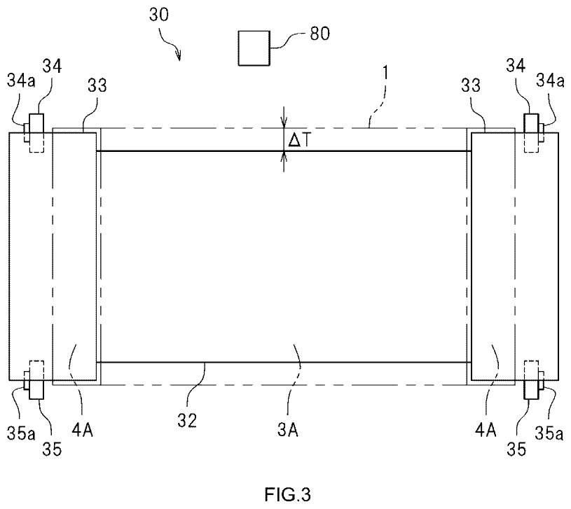

As illustrated in FIG. 1, the sheet conveying device 10 is configured to turn the electrode sheet 1 during conveyance to change a conveyance direction. The electrode sheet 1 is obtained by applying a coating material 3 (paste) including an electrode active material to one surface of an electrode foil 2, and is formed into a band-like shape. The electrode sheet 1 includes a coated surface 1A on which the coating material 3 is applied and a non-coated surface 1B that is a back surface of the coated surface 1A. The electrode sheet 1 includes a pair of non-coated areas 4A in which the coating material 3 is not applied at both end portions of the coated surface 1A in a width direction. (See FIG. 2 and FIG. 3. Note that, in FIG. 2 and FIG. 3, the coated surface 1A is a lower surface of the electrode sheet 1.) An area of the coated surface 1A in which the coating material 3 is applied will be hereinafter also referred to as a coated area 3A hereinafter. An illustrated portion of the sheet conveying device 10 in each of FIG. 2 and FIG. 3 is a portion that conveys the electrode sheet 1 in a state where the coating material 3 is not dried yet herein. However, the illustrated portion of the sheet conveying device 10 may be a portion that conveys the electrode sheet 1 after the coating material 3 is dried.

As illustrated in FIG. 1, the sheet conveying device 10 includes a first conveying portion 20 at which the electrode sheet 1 is conveyed, a turn portion 30 provided at downstream of the first conveying portion 20 in the conveyance direction of the electrode sheet 1, a second conveying portion 40 provided at downstream of the turn portion 30 in the conveyance direction of the electrode sheet 1, an air jet device 50 that jets air to cause the electrode sheet 1 to float at the turn portion 30, and a winding device 60 provided further at downstream of the second conveying portion 40 in the conveyance direction of the electrode sheet 1. Each of the first conveying portion 20 and the second conveying portion 40 is provided substantially horizontally herein. At the first conveying portion 20, the electrode sheet 1 is conveyed with the coated surface 1A facing downward. The electrode sheet 1 is turned with the coated surface 1A facing inside such that the non-coated surface 1B becomes down at the turn portion 30. The electrode sheet 1 is turned, and thus, an upper surface and a lower surface of the electrode sheet 1 are replaced with each other. The electrode sheet 1 is conveyed with the non-coated surface 1B facing downward in the second conveying portion 40. The second conveying portion 40 is arranged below the first conveying portion 20.

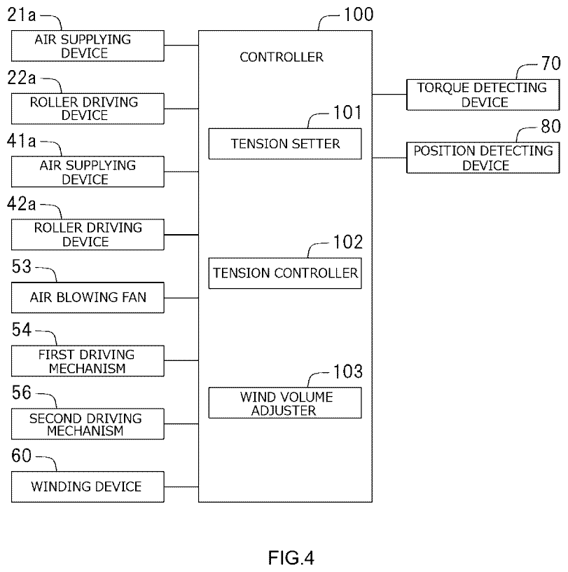

The first conveying portion 20 includes upstream side air nozzles 21 that jet air toward the coated surface 1A of the electrode sheet 1. The first conveying portion 20 is configured to cause the electrode sheet 1 to float by the air jetted thereby. Thus, the undried (or dried) coating material 3 contacts the sheet conveying device 10, so that peeling of the coating material 3 or the like is prevented. The upstream side air nozzles 21 are arranged below a conveyance path of the electrode sheet 1 in the first conveying portion 20 and jet air upward. Upstream side conveying rollers 22 are provided above the conveyance path of the electrode sheet 1 in the first conveying portion 20. The upstream side conveying rollers 22 contact the non-coated surface 1B of the electrode sheet 1 and conveys the electrode sheet 1 to a downstream side. As illustrated in FIG. 4, the first conveying portion 20 includes an air supplying device 21a that supplies compressed air to the upstream side air nozzles 21 and a roller driving device 22a that rotates the upstream side conveying rollers 22.

In the present embodiment, the upstream side air nozzles 21 also serve as nozzles that jet air to dry the coating material 3. In the present embodiment, the electrode sheet 1 is dried while being conveyed by the sheet conveying device 10. However, the sheet conveying device 10 may be configured to convey the electrode sheet 1 in a state where the coating material 3 is not dried to a separately provided dryer.

The turn portion 30 includes a convex surface 31 along which the electrode sheet 1 moves when being turned. The air jet device 50 is configured to blow air outward from the convex surface 31 in a radial direction of the convex surface 31. Thus, the coated area 3A of the electrode sheet 1 is conveyed in a state of being separated from the convex surface 31. The coated area 3A is separated from the convex surface 31, and thus, damage of the coated area 3A caused by contact with the turn portion 30 is prevented. Detailed configurations of the turn portion 30 and the air jet device 50 will be described later.

The second conveying portion 40 includes downstream side air nozzles 41 that jet air toward the coated surface 1A of the electrode sheet 1. The downstream side air nozzles 41 are arranged above the conveyance path of the electrode sheet 1 in the second conveying portion 40 and jet air downward. The electrode sheet 1 is conveyed such that the coated surface 1A faces upward at the second conveying portion 40. Downstream side conveying rollers 42 are provided below the conveyance path of the electrode sheet 1 at the second conveying portion 40. The downstream side conveying rollers 42 contact the non-coated surface 1B that has become the lower surface of the electrode sheet 1 and conveys the electrode sheet 1 to a downstream side. As illustrated in FIG. 4, the second conveying portion 40 includes an air supplying device 41a that supplies compressed air to the downstream side air nozzles 41 and a roller driving device 42a that rotates the downstream side conveying rollers 42.

The winding device 60 winds the electrode sheet 1 to pull the electrode sheet 1 to a downstream side in the conveyance direction. A tension is applied to the electrode sheet 1 by the winding device 60. The winding device 60 is an example of a pulling device that pulls the electrode sheet 1. However, the pulling device may be, for example, a pair of nip rollers that convey the electrode sheet 1. When the pulling device is the pair of nip rollers, the pair of nip rollers are rotated with the electrode sheet 1 interposed therebetween, and thus, the electrode sheet 1 is pulled. The winding device 60 includes an unillustrated motor a winding torque of which changes in accordance with a current that is caused to flow herein.

The sheet conveying device 10 includes a torque detecting device 70 that detects a torque with which the winding device 60 pulls the electrode sheet 1. The winding device 60 controls a current that is caused to flow in the motor to thus cause the winding torque to be a preset torque, based on the torque detected by the torque detecting device 70. The winding device 60 pulls the electrode sheet 1 such that a preset tension is applied by the control described above. However, a configuration of the winding device 60 devised in order to pull the electrode sheet 1 with the preset tension is not limited thereto. For example, the winding device 60 may be simply configured to apply the preset tension to the electrode sheet 1 by causing a current corresponding to the tension to flow in the motor. In this case, the sheet conveying device 10 may not include the torque detecting device 70.

### Configuration of Turn Portion

A configuration of the turn portion 30 will be described below. FIG. 2 is a perspective view of the turn portion 30. FIG. 3 is a schematic front view of the turn portion 30. As illustrated in FIG. 2 and FIG. 3, the turn portion 30 includes the convex surface 31 an axial line of which extends in the width direction of the electrode sheet 1. The turn portion 30 turns the electrode sheet 1 along the convex surface 31 such that the coated surface 1A faces inside. As illustrated in FIG. 2 and FIG. 3, the convex surface 31 includes a small-diameter portion 32, a pair of large-diameter portions 33 arranged at both sides of the small-diameter portion 32 in an axial direction (the width direction of the electrode sheet 1), a pair of upstream side auxiliary rollers 34 each of which abuts on a corresponding one of the pair of large-diameter portions 33, and a pair of downstream side auxiliary rollers 35 each of which abuts on a corresponding one of the pair of large-diameter portions 33.

As illustrated in FIG. 1, the small-diameter portion 32 is formed into a semicircular shape an axial line of which extends in the width direction of the electrode sheet 1. In the present embodiment, the small-diameter portion 32 extends to an upstream side of a highest point at 12 o'clock in the conveyance direction of the electrode sheet 1. The small-diameter portion 32 is formed to be larger than a semicircle (corresponding to 180 degrees). The small-diameter portion 32 is formed to have a circumference with a larger angle than 180 degrees.

As illustrated in FIG. 2, the pair of large-diameter portions 33 are arranged at both sides of the small-diameter portion 32 in the axial direction and protrude outward from the small-diameter portion 32 in the radial direction. Each of the large-diameter portions 33 is formed concentrically with the small-diameter portion 32. A radius of each of the large-diameter portions 33 is larger than a radius of the small-diameter portion 32. A difference between the radius of each of the large-diameter portions 33 and the radius of the small-diameter portion 32 is preferably, for example, 1 mm or more and 5 mm or less. The pair of large-diameter portions 33 support the both end portions of the electrode sheet 1 in the width direction, more specifically, the non-coated areas 4A provided at both ends of the coated surface 1A. The electrode sheet 1 contacts the turn portion 30 (the large-diameter portions 33) at the non-coated areas 4A provided at the both ends. The small-diameter portion 32 is opposed to a central portion of the electrode sheet 1 in the width direction, that is, the coated area 3A, herein. The coated area 3A of the electrode sheet 1 does not contact either the small-diameter portion 32 or the pair of large-diameter portions 33.

The pair of large-diameter portions 33 are configured to be rotatable around a rotation shaft 33a that extends in the axial direction (the width direction of the electrode sheet 1). The turn portion 30 includes a supporting member 36 that rotatably supports the pair of large-diameter portions 33. An outer portion of each of the large-diameter portions 33 in the axial direction is rotatably supported by the supporting member 36. In the present embodiment, each of the large-diameter portions 33 is supported on one side by the supporting member 36. However, each of the large-diameter portions 33 may be rotatably supported also by the small-diameter portion 32. Note that, herein, the supporting member 36 also supports the small-diameter portion 32 in a nonrotatable manner.

As illustrated in FIG. 2, multiple suction holes 33b through which air is sucked are formed in each of the large-diameter portions 33. Each of the large-diameter portions 33 is formed to be hollow and has an internal space (not illustrated). Each of the suction holes 33b is a substantially circular through hole formed so as to pass through a circumferential surface of a corresponding one of the large-diameter portions 33 and communicates with the internal space of the large-diameter portion 33. The multiple suction holes 33b are arranged around the entire circumference of the large-diameter portion 33. However, three is no particular limitation on a shape, an arrangement, or the like of the suction holes 33b.

The turn portion 30 includes a pair of pressure reduction pipes 37 via which air is sucked out from each of the internal spaces of the pair of large-diameter portions 33. The pressure reduction pipes 37 are connected to the rotation shaft 33a of the large-diameter portions 33 and communicate with the internal spaces of the large-diameter portions 33. An unillustrated fan is connected to the other end of each of the pressure reduction pipes 37. When the fan is driven, a pressure in the internal space of each of the large-diameter portion 33 is reduced and outside air is sucked through the multiple suction holes 33b formed in the circumferential surface of the large-diameter portion 33. Thus, the electrode sheet 1 (specifically, the non-coated areas 4A) supported by the large-diameter portions 33 is sucked on the large-diameter portion 33. The electrode sheet 1 is pressed against the large-diameter portions 33 by the tension applied by the winding device 60 and is sucked on the large-diameter portions 33 due to reduction in pressure in the internal spaces of the large-diameter portions 33. However, the large-diameter portions 33 are not provided with a mechanism that sucks the electrode sheet 1. In that case, the electrode sheet 1 may be pressed against the large-diameter portion 33 only by the tension applied by the winding device 60.

The pair of upstream side auxiliary rollers 34 are configured such that each of the upstream side auxiliary rollers 34 is rotatable around a rotation axis 34a that extends in parallel to the rotation shaft 33a of the pair of large-diameter portions 33. The supporting member 36 rotatably supports the pair of upstream side auxiliary rollers 34. Each of the pair of upstream side auxiliary rollers 34 abuts on a corresponding one of the pair of large-diameter portions 33. Therefore, when the pair of large-diameter portions 33 rotate, the pair of upstream side auxiliary rollers 34 rotate following rotation of the large-diameter portions 33. The pair of upstream side auxiliary rollers 34 are provided at upstream of the small-diameter portion 32 in the conveyance direction of the electrode sheet 1 herein. The pair of upstream side auxiliary rollers 34 are arranged above a central axis of the small-diameter portion 32 and the large-diameter portions 33 (the rotation shaft 33a of the large-diameter portions 33). Each of the pair of upstream side auxiliary rollers 34 abuts on a semicircular arc portion of a corresponding one of the large-diameter portions 33 at an opposite side to a semicircular arc portion (a semicircular arc portion arranged so as to be aligned with the small-diameter portion 32) that supports the electrode sheet 1. The pair of upstream side auxiliary rollers 34 suppress deviation of rotation of the large-diameter portions 33 around the rotation shaft 33a. The pair of upstream side auxiliary rollers 34 receive the large-diameter portions 33 pressed toward the first conveying portion 20 (a right side in FIG. 1) to suppress rotation deviation of the large-diameter portions 33.

The pair of downstream side auxiliary rollers 35 are also configured such that each of the downstream side auxiliary rollers 35 is rotatable round a rotation shaft 35a that extends in parallel to the rotation shaft 33a of the pair of large-diameter portions 33. The supporting member 36 rotatably supports the pair of downstream side auxiliary rollers 35. Each of the pair of downstream side auxiliary rollers 35 also abuts on a corresponding one of the large-diameter portions 33 and, when the pair of large-diameter portions 33 rotate, rotates following rotation of the large-diameter portions 33. The pair of downstream side auxiliary rollers 35 are provided at downstream of the small-diameter portion 32 in the conveyance direction of the electrode sheet 1. The pair of downstream side auxiliary rollers 35 are arranged below the central axis of the small-diameter portion 32 and the large-diameter portions 33 (the rotation shaft 33a of the large-diameter portions 33). Each of the pair of downstream side auxiliary rollers 35 also abuts on a semicircular arc portion of a corresponding one of the large-diameter portions 33 at an opposite side to a semicircular arc portion thereof that supports the electrode sheet 1. The pair of downstream side auxiliary rollers 35 suppresses deviation of rotation of the large-diameter portions 33 around the rotation shaft 33a with the upstream side auxiliary rollers 34. Note that, as for the upstream side auxiliary rollers 34 and the downstream side auxiliary rollers 35, two separate upstream side auxiliary rollers 34 and two separate downstream side auxiliary rollers 35 may not be provided, and one long upstream side auxiliary roller 34 and one long downstream side auxiliary roller 35 may be provided.

As illustrated in FIG. 3, the sheet conveying device 10 includes a position detecting device 80 that detects a position of the electrode sheet 1 in the turn portion 30. The position detecting device 80 detects a difference ΔT in position at the radial direction of the small-diameter portion 32 between the both end portions (herein, the non-coated areas 4A) of the electrode sheet 1 in the width direction which are supported by the pair of large-diameter portions 33 and the central portion (herein, the coated area 3A) of the electrode sheet 1 in the width direction which floats over the small-diameter portion 32. A vertical position of each of the both end portions of the electrode sheet 1 in the width direction which are supported by the pair of large-diameter portions 33 is known in advance. The position detecting device 80 detects a vertical position of the central portion of the electrode sheet 1 in the width direction which floats over the small-diameter portion 32. The difference ΔT in position in the radial direction between the both end portions and the central portion of the electrode sheet 1 is obtained by subtracting a height of the both end portions of the electrode sheet 1 which is known in advance from a measured height of the central portion of the electrode sheet 1. However, the position detecting device 80 may measure the height of the both end portions of the electrode sheet 1. The position detecting device 80 is, for example, a non-contact type laser displacement meter. However, there is no particular limitation on the position detecting device 80 and the position detecting device 80 may be, for example, a contact type displacement meter.

### Configuration of Air Jet Device

As illustrated in FIG. 1, the air jet device 50 includes an air nozzle 51 provided at a boundary portion between the first conveying portion 20 and the turn portion 30, multiple air jet holes 52 provided in the small-diameter portion 32 of the turn portion 30, and an air blowing fan 53 that generates wind. The air jet device 50 drives the air blowing fan 53 to jet air from the air nozzle 51 and the multiple air jet holes 52. As illustrated in FIG. 1, the small-diameter portion 32 is formed to be hollow. The air blowing fan 53 sends wind to an internal space 32a of the small-diameter portion 32. The small-diameter portion 32 includes an air inlet port 32b through which air is introduced to the internal space 32a. The air inlet port 32b is connected to the air blowing fan 53. The air nozzle 51 and the multiple air jet holes 52 pass through the small-diameter portion 32 and communicate with the internal space 32a. Air supplied to the internal space 32a by the air blowing fan 53 is jetted from the air nozzle 51 and multiple air jet holes 52. Note that air may be supplied not by the air blowing fan 53 but by, for example, an air compressor that generates compressed air.

The air jet holes 52 is a through hole having a substantially circular cross section. In the present embodiment, the multiple air jet holes 52 are arranged evenly in the whole arc portion of the small-diameter portion 32. However, there is no particular limitation on shapes and arrangement of the multiple air jet holes 52. For example, some or all of the multiple air jet holes 52 may be configured to have a long hole shape that is long in the width direction of the electrode sheet 1. The multiple air jet holes 52 may be arranged, for example, such that a density thereof is higher at the upstream side than at the downstream side in the conveyance direction of the electrode sheet 1.

As illustrated in FIG. 2, the air nozzle 51 is formed to have a slit shape that extends in the width direction of the electrode sheet 1. The air nozzle 51 is arranged at upstream of a highest point of the small-diameter portion 32 at 12 o'clock in the conveyance direction of the electrode sheet 1 herein. The air nozzle 51 is formed such that a width (denoted by W1 in FIG. 1) thereof in the conveyance direction of the electrode sheet 1 can be changed.

As illustrated in FIG. 1, the air nozzle 51 includes a downstream side block 51a that forms a downstream side wall of the air nozzle 51 and an upstream side plate 51b that is arranged at upstream of the downstream side block 51a and forms an upstream side wall of the air nozzle 51. Each of the upstream side plate 51b and the downstream side block 51a is configured to be movable in the conveyance direction of the electrode sheet 1. The width W1 of the air nozzle 51 can be changed by moving at least one of the upstream side plate 51b and the downstream side block 51a such that a space between the upstream side plate 51b and the downstream side block 51a is changed.

The upstream side plate 51b has a flat plate-like shape that extends in the width direction and in the conveyance direction of the electrode sheet 1. The upstream side plate 51b is configured to be movable along an unillustrated guide member in the conveyance direction of the electrode sheet 1. When the upstream side plate 51b is moved to the downstream side in the conveyance direction of the electrode sheet 1, the width W1 of the air nozzle 51 is reduced. Thus, a wind volume of air from the air nozzle 51 is reduced and a wind speed (wind pressure) is increased. When the upstream side plate 51b is moved to an upstream side in the conveyance direction of the electrode sheet 1, the width W1 of the air nozzle 51 is increased. Thus, the wind volume of air from the air nozzle 51 is increased and the wind speed (wind pressure) is reduced.

The air jet device 50 includes a first driving mechanism 54 that moves the upstream side plate 51b in the conveyance direction of the electrode sheet 1. The first driving mechanism 54 includes a motor and a ball screw mechanism herein. However, there is no particular limitation on a configuration of the first driving mechanism 54. The first driving mechanism 54 may include, for example, a motor, a pulley, and a belt.

The downstream side block 51a is formed to have a trapezoidal cross section and extends in the width direction of the electrode sheet 1. An upper slope 51a1 of the downstream side block 51a forms the downstream side wall of the air nozzle 51. As illustrated in FIG. 1, the upper slope 51a1 of the downstream side block 51a is upwardly inclined toward the downstream side in the conveyance direction of the electrode sheet 1. The upper slope 51a1 of the downstream side block 51a is formed to be nonparallel to the upstream side plate 51b. Therefore, the upper slope 51a1 of the downstream side block 51a and the upstream side plate 51b form a nozzle a width of which reduces as proceeding toward the downstream side in the conveyance direction of the electrode sheet 1. Air from the air nozzle 51 is jetted in an extension direction of the upper slope 51a1 of the downstream side block 51a. The air from the air nozzle 51 is jetted along the upper slope 51a1 of the downstream side block 51a to the downstream side in the conveyance direction and diagonally upward.

In the present embodiment, the downstream side block 51a is configured to move along the convex surface 31 of the turn portion 30 in a circumferential direction of the convex surface 31. The downstream side block 51a moves along an inner circumferential surface of the small-diameter portion 32 and thus moves in the conveyance direction of the electrode sheet 1, herein. In the present embodiment, the downstream side block 51a rotates and moves around a center C1 of the turn portion 30, so that the width W1 of the air nozzle 51 and an angle of the upper slope 51a1 with respect to a vertical direction change. The air jet device 50 is configured such that an angle of a straightening plate 57 can be adjusted. When the angle of the upper slope 51a1 changes, a direction in which the air from the air nozzle 51 is blown out changes. An arm 55 that supports the downstream side block 51a and rotates around the center C1 of the turn portion 30 is connected to the downstream side block 51a. The arm 55 is caused to rotate around the center C1 of the turn portion 30 by a second driving mechanism 56. The second driving mechanism 56 includes, for example, a stepping motor or a servo motor that can control a rotation angle. Note that the downstream side block 51a may be configured to change the width of the air nozzle 51, for example, by moving in a horizontal direction.

As illustrated in FIG. 1, a lower slope 51a2 of the downstream side block 51a is downwardly inclined toward the downstream side in the conveyance direction of the electrode sheet 1. The straightening plate 57 is fixed to the lower slope 51a2 of the downstream side block 51a. The straightening plate 57 is provided on the downstream side block 51a and moves with the downstream side block 51a. Herein, the straightening plate 57 rotates and moves around the center C1 with the downstream side block 51a and, along with rotation and movement thereof, an angle θ of the straightening plate 57 with respect to the vertical direction changes. The straightening plate 57 extends to a point at downstream of the downstream side block 51a in the conveyance direction of the electrode sheet 1. The straightening plate 57 is bent downward after extending so as to be downwardly inclined along an extension line of the lower slope 51a2 of the downstream side block 51a toward the downstream side in the conveyance direction. Although not illustrated, the straightening plate 57 extends in the width direction of the electrode sheet 1.

The straightening plate 57 forms a portion of a wall surface of an air inlet port 57a that communicates with the air nozzle 51. Wind generated by the air blowing fan 53 enters the air inlet port 57a formed by the straightening plate 57 and a rear wall 32c of the small-diameter portion 32 and is jetted from the air nozzle 51. When the downstream side block 51a is moved to the downstream side in the conveyance direction of the electrode sheet 1, the extension direction of the straightening plate 57 is closer to the vertical direction (the angle θ is reduced). Thus, a gap between the straightening plate 57 and the rear wall 32c of the small-diameter portion 32 is reduced. That is, a width of the air inlet port 57a formed between the straightening plate 57 and the rear wall 32c of the small-diameter portion 32 is reduced. As a result, an amount of air that flows in the air inlet port 57a is reduced and the wind volume of air from the air nozzle 51 is reduced.

When the downstream side block 51a is moved to the upstream side in the conveyance direction of the electrode sheet 1, the extension direction of the straightening plate 57 is closer to the horizontal direction (the angle θ is increased). Thus, the width of the air inlet port 57a is increased. As a result, the amount of air that flows in the air inlet port 57a is increased and the wind volume of air from the air nozzle 51 is increased.

### Control Block Diagram

FIG. 4 is a block diagram of the sheet conveying device 10. As illustrated in FIG. 4, a controller 100 of the sheet conveying device 10 is connected to the air supplying device 21a and the roller driving device 22a of the first conveying portion 20, the air supplying device 41a and the roller driving device 42a of the second conveying portion 40, the winding device 60, the air blowing fan 53 of the air jet device 50, the first driving mechanism 54, and the second driving mechanism 56 and controls operations of the above-described components. The controller 100 is connected to the torque detecting device 70 and the position detecting device 80 and receives signals therefrom.

There is no particular limitation on a configuration of the controller 100. The controller 100 includes, for example, a microcomputer. The microcomputer may include, for example, an interface (I/F) that receives data or the like from an external device, a central processing unit (CPU) that executes an instruction of a program, a read only memory (ROM) that stores the program executed by the CPU, a random access memory (RAM) that is used as a working area in which the program is developed, and a storage device, such as a memory or the like, that stores the program or various types of data.

As illustrated in FIG. 4, the controller 100 includes a tension setter 101, a tension controller 102, and a wind volume adjuster 103. In the tension setter 101, a tension that is applied to the electrode sheet 1, specifically, a winding torque of the winding device 60, can be set. The tension controller 102 performs feedback control on a torque to which the winding torque of the winding device 60 has been set, based on a detection result of the torque detecting device 70.

The wind volume adjuster 103 adjusts the width W1 of the air nozzle 51 such that the difference ΔT in position in the radial direction between the both end portions and the central portion of the electrode sheet 1 which is detected by the position detecting device 80 is in a preset range. The wind volume adjuster 103 performs feedback control on the width W1 of the air nozzle 51 in the conveyance direction such that the difference ΔT in position is closer to the preset range. Specifically, the wind volume adjuster 103 controls the first driving mechanism 54 to control a position of the upstream side plate 51b.

### Control of Air Nozzle Width

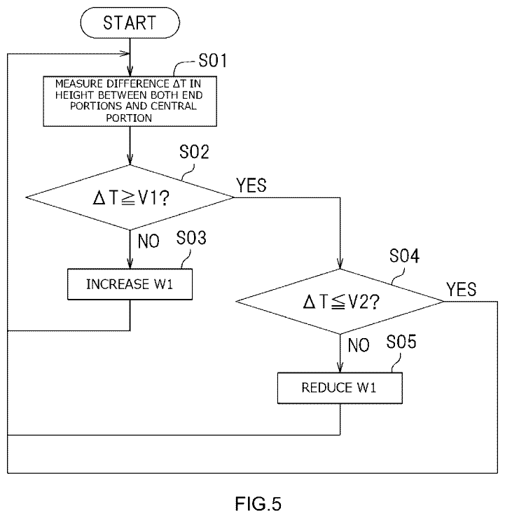

A process of control of the width W1 of the air nozzle 51 will be described below. FIG. 5 illustrates an example of a flowchart related to control of the width of the air nozzle 51. As illustrated in FIG. 5, in control of the width of the air nozzle 51 according to the example, in Step S01, the difference ΔT in position in the radial direction between the both end portions and the central portion of the electrode sheet 1 is measured. In Step S02, whether the difference ΔT in position between the both end portions and the position of the central portion of the electrode sheet 1 is equal to or larger than a predetermined lower limit value V1, that is, whether the electrode sheet 1 does not hang below a lower limit, is determined. When the difference ΔT is lower than the lower limit value V1 (when a result of Step S02 is NO), the width W1 of the air nozzle 51 is increased by a preset width in Step S03. After Step S03, the process returns to Step S01 and feedback control is repeated.

When the result of Step S02 is YES (when the difference ΔT in position between the both end portions and the central portion of the electrode sheet 1 is equal to or larger than the lower limit value V1), whether the difference ΔT in position between the both end portions and the central portion is equal to or smaller than a predetermined upper limit value V2, that is, whether the electrode sheet 1 is not inflated above an upper limit is determined in Step S04. When the difference ΔT exceeds the upper limit value V2 (a result of Step S04 is NO), the width W1 of the air nozzle 51 is reduced by a preset width in Step S05. After Step S05, the process returns to Step S01 and feedback control is repeated.

When the result of Step S04 is YES (when the difference ΔT is equal to or smaller than the upper limit value V2), the difference ΔT in position between the both end portions and the central portion of the electrode sheet 1 is between the lower limit value V1 and the upper limit value V2, that is, in a preset range. In this case, the width W1 of the air nozzle 51 is not changed. The process returns to Step S01 and feedback control is repeated. When the difference ΔT in position between the both end portions and the central portion of the electrode sheet 1 is between the lower limit value V1 and the upper limit value V2, a gap that is equal to or larger than the lower limit value V1 is ensured between the central portion of the electrode sheet 1 and the small-diameter portion 32. Therefore, in this state, the coated area 3A of the electrode sheet 1 is less likely to contact the small-diameter portion 32. In this state, an inconvenience (for example, stretching of the electrode sheet 1) caused by an excessively increased internal pressure in a space between the small-diameter portion 32 and the electrode sheet 1 is suppressed.

The angle θ of the straightening plate 57 (a rotation position of the downstream side block 51a around the center C1) is adjusted when the difference ΔT in position in the radial direction of the small-diameter portion 32 which is detected by the position detecting device 80 is not in the preset range depending on control of the position of the upstream side plate 51b,. When the central portion of the electrode sheet 1 is positioned low in the vertical direction (the central position of the electrode sheet 1 hangs down) even after the upstream side plate 51b has been moved to a most downstream point, a person in charge of adjustment drives the second driving mechanism 56 to increase the angle θ. When the central portion of the electrode sheet 1 is positioned high in the vertical direction (the central position of the electrode sheet 1 is inflated) even after the upstream side plate 51b has been moved to a most upstream point, the person in charge of adjustment drives the second driving mechanism 56 to reduce the angle θ. Changing the angle θ is performed when, for example, specifications (for example, a thickness, a width, a material, or the like) of the electrode sheet 1 are changed, and the difference ΔT cannot be controlled any more by feedback control performed till then.

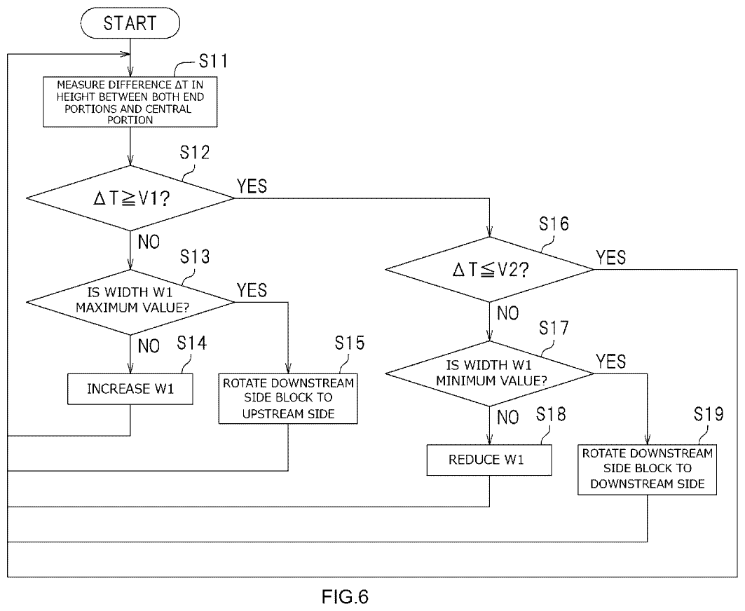

Note that, as a modified example, the angle θ of the straightening plate 57 may be controlled with the width W1 of the air nozzle 51. FIG. 6 is an example of a flowchart related to control of the width of the air nozzle 51 and the angle θ of the straightening plate 57. Step S11 and Step S12 of FIG. 6 are similar to Step S01 and Step S02 of FIG. 5, respectively. In Step S12, when the difference ΔT is smaller than the lower limit value V1 (when a result of the Step S12 is NO), in this modified example, whether the width W1 of the air nozzle 51 has reached a maximum value is determined in Step S13. When a result of Step S13 is NO (when the width W1 of the air nozzle 51 has not reached the maximum value), the width W1 of the air nozzle 51 is increase by a preset width in Step S14. After Step S14, the process returns to Step S11.

When the result of Step S13 is YES (when the width W1 of the air nozzle 51 has reached the maximum value), the downstream side block 51a and the straightening plate 57 are rotated such that the angle θ is increased by a preset angle in Step S15. Thus, the wind volume of air that is jetted from the air nozzle 51 is increased. After Step S15, the process returns to Step S11.

Step S16 of FIG. 6 is slimier to Step S04 of FIG. 5. In Step S16, when the difference ΔT exceeds the upper limit value V2 (when a result of Step S16 is NO), whether the width W1 of the air nozzle 51 has reached a minimum value is determined in Step S17. When a result of Step S17 is NO (when the width W1 of the air nozzle 51 has not reached the minimum value), the width W1 of the air nozzle 51 is reduced by a preset width in Step S18. After Step S18, the process returns to Step S11.

When the result of Step S17 is YES (when the width W1 of the air nozzle 51 has reached the minimum value), the downstream side block 51a and the straightening plate 57 are rotated such that the angle θ is reduced by a preset angle in Step S19. Thus, the wind volume of air that is jetted from the air nozzle 51 is reduced. After Step S19, the process returns to Step S11. For example, a width of the air inlet port 57a also can be feedback-controlled with the width 1 of the air nozzle 51 by the control described above.

### Functions and Effects of Present Embodiment

Functions and effects that can achieved by the sheet conveying device 10 according to the present embodiment will be described below.

The sheet conveying device 10 according to the present embodiment includes the first conveying portion 20 at which the band-like electrode sheet 1 including the coated surface 1A and the non-coated surface 1B on an opposite side of the coated surface 1A is conveyed with the coated surface 1A facing downward, the turn portion 30 that includes the convex surface 31 the axial line of which extends in the width direction of the electrode sheet 1, is provided at downstream of the first conveying portion 20 in the conveyance direction of the electrode sheet 1, and turns the electrode sheet 1 along the convex surface 31 with the coated surface 1A facing inside, the second conveying portion 40 that is provided at downstream of the turn portion 30 in the conveyance direction and at which the electrode sheet 1 is conveyed with the non-coated surface 1B facing downward, and the air jet device 50 that includes the air nozzle 51 that is provided at the boundary portion between the first conveying portion 20 and the turn portion 30 and extends in the width direction of the electrode sheet 1 and jets air from the air nozzle 51. The air nozzle 51 is configured such that the width W1 thereof in the conveyance direction can be adjusted.

According to the configuration described above, the wind volume and the wind speed of air that is jetted from the air nozzle 51 can be adjusted by adjusting the width W1 of the air nozzle 51 in the conveyance direction of the electrode sheet 1. The sheet conveying device 10 in which the electrode sheet 1 is even less likely to contact the turn portion 30 can be realized by adjusting the wind volume and the wind speed of air that is jetted from the air nozzle 51.

In the present embodiment, the air nozzle 51 includes the downstream side block 51a that forms the downstream side wall of the air nozzle 51 and the upstream side plate 51b that is arranged at upstream of the downstream side block 51a and forms the upstream side wall of the air nozzle 51. Each of the upstream side plate 51b and the downstream side block 51a is configured to be movable in the conveyance direction of the electrode sheet 1. According to the configuration described above, the width W1 of the air nozzle 51 can be changed by moving at least one of the upstream side plate 51b and the downstream side block 51a. Note that, as long as the air nozzle 51 has a configuration in which at least one of the upstream side plate 51b and the downstream side block 51a can be movable, the width W1 of the air nozzle 51 can be changed. In case that the air nozzle 51 has a configuration in which the upstream side plate 51b and the downstream side block 51a can be movable respectively, the position of the air nozzle 51 also can be changed. In the present embodiment, the downstream side block 51a is moved in the conveyance direction of the electrode sheet 1 by rotating the downstream side block 51a.

In the present embodiment, the air jet device 50 includes the straightening plate 57 that is provided at the downstream side block 51a and moves with the downstream side block 51a. The downstream side block 51a is configured to move along the convex surface 31 of the turn portion 30 in the circumferential direction of the convex surface 31. The straightening plate 57 is configured such that the angle θ with respect to the vertical direction changes as the straightening plate 57 moves with the downstream side block 51a. The straightening plate 57 forms a portion of the wall surface of the air inlet port 57a that communicates with the air nozzle 51. According to the configuration described above, the angle θ of the straightening plate 57 can be changed by moving the downstream side block 51a along the convex surface 31. Thus, as described above, the wind volume of air from the air nozzle 51 can be adjusted in a wider range.

In the present embodiment, the convex surface 31 of the turn portion 30 includes the small-diameter portion 32 that is opposed to the central portion of the electrode sheet 1 in the width direction and the pair of large-diameter portions 33 that are arranged at both sides of the small-diameter portion 32 in the axial direction, protrude outward from the small-diameter portion 32 in the radial direction, and support the both end portions of the electrode sheet 1 in the width direction. According to the configuration described above, the central portion of the electrode sheet 1 in the width direction can be caused to be less likely to contact the turn portion 30 (herein, the small-diameter portion 32) by configuring the pair of large-diameter portions 33 each having a larger diameter than that of the small-diameter portion 32 such that the pair of large-diameter portions 33 support the both end portions of the electrode sheet 1 in the width direction. Moreover, with the large-diameter portions 33 configured to support the both end portions of the electrode sheet 1 in the width direction, flapping of the electrode sheet 1 caused by air jetted by the air jet device 50 can be suppressed.

The sheet conveying device 10 according to the present embodiment further includes the position detecting device 80 that detects the difference ΔT in position in the radial direction between the both end portions of the electrode sheet 1 in the width direction supported by the pair of large-diameter portions 33 and the central portion of the electrode sheet 1 in the width direction and the wind volume adjuster 103 that adjusts the width W1 of the air nozzle 51 in the conveyance direction such that the difference ΔT in position in the radial direction which is detected by the position detecting device 80 is in the preset range. According to the sheet conveying device 10 described above, the gap between the central portion of the electrode sheet 1 in the width direction and the small-diameter portion 32 can be ensured. As a result, the electrode sheet 1 can be caused to be less likely to contact the turn portion 30 (specifically, the small-diameter portion 32). Moreover, the difference ΔT in height between the both end portions and the central portion of the electrode sheet 1 can be caused to be equal to or less than a predetermined value, and therefore, creases generated in the non-coated areas 4A due to the difference ΔT in height can be suppressed. When the difference ΔT in height between the both end portions and the central portion of the electrode sheet 1 is large, it is likely that the electrode sheet 1 is bent at a step between each of the large-diameter portions 33 and the small-diameter portion 32 and creases are generated. Furthermore, an inconvenience (for example, stretching of the electrode sheet 1) caused by an excessively increased internal pressure in the space between the small-diameter portion 32 and the electrode sheet 1 can be also suppressed.

Specifically, in the present embodiment, the wind volume adjuster 103 performs feedback control of the width W1 of the air nozzle 51 in the conveyance direction such that the difference ΔT in position in the radial direction detected by the position detecting device 80 is closer to the preset range. According to the configuration described above, even when there are variations in conditions, for example, such as variations in the thickness of the electrode sheet 1 or the like, the difference ΔT in position in the radial direction between the both end portions and the central portion of the electrode sheet 1 in the width direction can be caused to be in the predetermined range.

### Other Preferred Embodiments

One preferred embodiment of the sheet conveying device proposed herein has been described above. However, the preferred embodiment described above is merely an example, and a sheet conveying device according to the present disclosure can be implemented in various other embodiments. The embodiment described above shall not limit the present disclosure, unless specifically stated otherwise. Various changes can be made to a technology described herein, and each of components and processes described herein can be omitted as appropriate or can be combined with another one or other ones of the components and the processes as appropriate, unless a particular problem occurs.

For example, a control range (the lower limit value V1 and the upper limit value V2) of the difference ΔT in position in the radial direction between the both end portions and the electrode sheet 1 in the width direction may be determined in accordance with a tension applied to the electrode sheet 1.

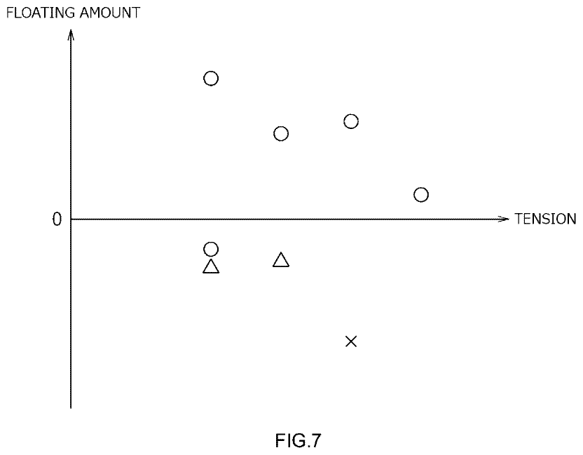

FIG. 7 is a graph illustrating a relationship between a floating amount of the electrode sheet 1, the tension that is applied to the electrode sheet 1, and whether there were creases generated in the electrode sheet 1. An abscissa in FIG. 7 indicates the tension applied to the electrode sheet 1. An ordinate in FIG. 7 indicates the floating amount of the electrode sheet 1. The floating amount “0” of the electrode sheet 1 expresses that ΔT was “0.” Points plotted with circles in FIG. 7 express conditions under which the degree of generation of creases was low and there was no problem. Points plotted with triangles express conditions under which the degree of generation of creases was mediate. A point plotted by a cross expresses conditions under which the degree of generation of creases was high and there was a problem.

The floating amount of the electrode sheet 1 differs depending on a position in the circumferential direction of the small-diameter portion 32. For example, when the wind volume of air from the air nozzle 51 is large, the wind volume of air from the air jet holes 52 of the small-diameter portion 32 is small and the floating amount of the portion of the electrode sheet 1 that is caused to float by the air from the air jet holes 52 is reduced. Therefore, a target floating amount of the electrode sheet 1 is preferably set with reference to conditions under which creases of the electrode sheet 1 are generated, as illustrated in FIG. 7. The target floating amount of the electrode sheet 1, that is, the control range of ΔT, is determined in accordance with the tension applied to the electrode sheet 1, based on data of results illustrated in FIG. 7. For example, the control range of ΔT may be determined to be closer to a floating amount at one of the points indicated by circles in FIG. 7 in accordance with the tension applied to the electrode sheet 1. According to a method for determining the control range of ΔT described above, the generation of creases of the electrode sheet 1 can be suppressed regardless of the tension applied to the electrode sheet 1.

Note that control that causes the difference ΔT in position in the radial direction between the both end portions and the central portions of the electrode sheet 1 in the width direction to be in the predetermined range is not limited to feedback control. For example, when the width W1 of the air nozzle 51 with which ΔT can be caused to be in the predetermined range is obtained in advance using a function of the sheet conveying device 10 that can adjust the width W1 of the air nozzle 51, the width W1 of the air nozzle 51 may be fixed.

The sheet conveying device 10 may be configured such that adjustment of the width W1 of the air nozzle 51 and the angle θ of the straightening plate 57 is manually performed. Adjustment of the width W1 of the air nozzle 51 and the angle θ of the straightening plate 57 may be performed by moving the upstream side plate 51b or the downstream side block 51a by the person in charge of adjustment without using a driving mechanism. A method for adjusting the sheet conveying device 10 may include a measuring step of measuring the difference ΔT in position in the radial direction between the both end portions of the electrode sheet 1 in the width direction supported by the pair of large-diameter portions 33 and the central portion of the electrode sheet 1 in the width direction and an adjusting step of adjusting the width W1 of the air nozzle 51 in the conveyance direction such that the difference ΔT in position in the radial direction measured in the measuring step is in the preset range. A device that measures the difference ΔT may be an external device that is not provided in the sheet conveying device 10.

The sheet conveying device is not limited to a device that conveys an electrode sheet of an electricity storage device and may be a device that conveys some other band-like sheet. For example, the small-diameter portion may have a circular arc shape exceeding a semicircle or less than a semicircle. The first conveying portion may be configured to convey a sheet with a coated portion facing downward, and the sheet may be conveyed in some other direction than the horizontal direction. The second conveying portion may be configured to convey the sheet with the coated portion facing upward, and the sheet may be conveyed in some other direction than the horizontal direction.

The present specification includes disclosure set force in the following items.
Item 1:
A sheet conveying device comprising:
   a first conveying portion at which a band-like sheet including a first surface and a second surface on an opposite side of the first surface is conveyed with the first surface facing downward;
   a turn portion that includes a convex surface an axial line of which extends in a width direction of the sheet, is provided at downstream of the first conveying portion in a conveyance direction of the sheet, and turns the sheet along the convex surface with the first surface facing inside;
   a second conveying portion provided at downstream of the turn portion in the conveyance direction and at which the sheet is conveyed with the second surface facing downward; and
   an air jet device that includes an air nozzle that is provided at a boundary portion between the first conveying portion and the turn portion and extends in the width direction of the sheet and jets air from the air nozzle,
   wherein
the air nozzle is configured such that a width thereof in the conveyance direction can be adjusted.
   Item 2:
The sheet conveying device according to Item 1, wherein
   the air nozzle includes
      a downstream side member that forms a downstream side wall of the air nozzle, and
      an upstream side member that is arranged at upstream of the downstream side member and forms an upstream side wall of the air nozzle, and
   at least one of the upstream side member and the downstream side member is configured to be movable in the conveyance direction.
   Item 3:
The sheet conveying device according to Item 2, wherein
   each of the upstream side member and the downstream side member is configured to be movable in the conveyance direction.
   Item 4:
The sheet conveying device according to Item 3, wherein
   the downstream side member is configured to move along the convex surface in a circumferential direction of the convex surface,
   the air jet device includes a straightening plate that is provided at the downstream side member and whose angle with respect to a vertical direction changes as moving with the downstream side member, and
   the straightening plate forms a portion of a wall surface of an air inlet port communicating with the air nozzle.
   Item 5:
The sheet conveying device according to any one of Items1 to 4, wherein
   the convex surface includes
      a small-diameter portion that is opposed to a central portion of the sheet in the width direction, and
      a pair of large-diameter portions that are arranged at both sides of the small-diameter portion in an axial direction, protrude outward from the small-diameter portion in a radial direction, and support both end portions of the sheet in the width direction.
   Item 6:
The sheet conveying device according to Item 5, further comprising:
   a position detecting device that detects a difference in position in the radial direction between the both end portions of the sheet in the width direction supported by the pair of large-diameter portions and the central portion of the sheet in the width direction; and
   an adjuster that adjusts a width of the air nozzle in the conveyance direction such that the difference in position in the radial direction detected by the position detecting device is in a preset range.
   Item 7:
The sheet conveying device according to Item 6, wherein
   the adjuster performs feedback control on the width of the air nozzle in the conveyance direction such that the difference in position in the radial direction detected by the position detecting device is closer to the preset range.
   Item 8:
The sheet conveying device according to Item 6 or 7, further comprising:
   a pulling device that is arranged at downstream of the second conveying portion in the conveyance direction and pulls the sheet such that a preset tension is applied,
   wherein
   the preset range is determined in accordance with the tension applied to the sheet.
   Item 9:
A method for adjusting a sheet conveying device that includes a first conveying portion at which a band-like sheet including a first surface and a second surface on an opposite side of the first surface is conveyed with the first surface facing downward, a turn portion that includes a convex surface an axial line of which extends in a width direction of the sheet, is provided at downstream of the first conveying portion in a conveyance direction of the sheet, and turns the sheet along the convex surface with the first surface facing inside, a second conveying portion provided at downstream of the turn portion in the conveyance direction and at which the sheet is conveyed with the second surface facing downward, and an air jet device that includes an air nozzle that is provided at a boundary portion between the first conveying portion and the turn portion and extends in the width direction of the sheet and jets air from the air nozzle,
   the convex surface including
      a small-diameter portion that is opposed to a central portion of the sheet in the width direction, and
      a pair of large-diameter portions that are arranged at both sides of the small-diameter portion in an axial direction, protrude outward from the small-diameter portion in a radial direction, and support both end portions of the sheet in the width direction,
   the air nozzle being configured such that a width thereof in the conveyance direction can be adjusted,
the method comprising:
   measuring a difference in position in the radial direction between the both end portions of the sheet in the width direction supported by the pair of large-diameter portions and the central portion of the sheet in the width direction; and
   adjusting the width of the air nozzle in the conveyance direction such that the measured difference in position in the radial direction is in a preset range.
   Item 10:
The method for adjusting a sheet conveying device according to Item 9, wherein
   the sheet conveying device further includes a pulling device that is arranged at downstream of the second conveying portion and pulls the sheet, and
   the preset range is determined in accordance with a tension applied to the sheet.
   Item 11:
The method for adjusting a sheet conveying device according to Item 9 or 10, wherein
   the air jet device includes a straightening plate that forms a portion of a wall surface of an air inlet port communicating with the air nozzle and is configured such that an angle of the straightening plate can be adjusted, and
   the adjusting of the width of the air nozzle includes adjusting the angle of the straightening plate such that the measured difference in position in the radial direction is in a preset range.

What is claimed is:

1. A sheet conveying device comprising:
a first conveying portion at which a band-like sheet including a first surface and a second surface on an opposite side of the first surface is conveyed with the first surface facing downward;
a turn portion that includes a convex surface an axial line of which extends in a width direction of the sheet, is provided at downstream of the first conveying portion in a conveyance direction of the sheet, and turns the sheet along the convex surface with the first surface facing inside;
a second conveying portion provided at downstream of the turn portion in the conveyance direction and at which the sheet is conveyed with the second surface facing downward; and
an air jet device that includes an air nozzle that is provided at a boundary portion between the first conveying portion and the turn portion and extends in the width direction of the sheet and jets air from the air nozzle,
wherein
the air nozzle is configured such that a width thereof in the conveyance direction can be adjusted.

2. The sheet conveying device according to claim 1, wherein
the air nozzle includes
a downstream side member that forms a downstream side wall of the air nozzle, and
an upstream side member that is arranged at upstream of the downstream side member and forms an upstream side wall of the air nozzle, and
at least one of the upstream side member and the downstream side member is configured to be movable in the conveyance direction.

3. The sheet conveying device according to claim 2, wherein
each of the upstream side member and the downstream side member is configured to be movable in the conveyance direction.

4. The sheet conveying device according to claim 3, wherein
the downstream side member is configured to move along the convex surface in a circumferential direction of the convex surface,
the air jet device includes a straightening plate that is provided at the downstream side member and whose angle with respect to a vertical direction changes as moving with the downstream side member, and
the straightening plate forms a portion of a wall surface of an air inlet port communicating with the air nozzle.

5. The sheet conveying device according to claim 1, wherein
the convex surface includes
a small-diameter portion that is opposed to a central portion of the sheet in the width direction, and
a pair of large-diameter portions that are arranged at both sides of the small-diameter portion in an axial direction, protrude outward from the small-diameter portion in a radial direction, and support both end portions of the sheet in the width direction.

6. The sheet conveying device according to claim 5, further comprising:
a position detecting device that detects a difference in position in the radial direction between the both end portions of the sheet in the width direction supported by the pair of large-diameter portions and the central portion of the sheet in the width direction; and
an adjuster that adjusts a width of the air nozzle in the conveyance direction such that the difference in position in the radial direction detected by the position detecting device is in a preset range.

7. The sheet conveying device according to claim 6, wherein
the adjuster performs feedback control on the width of the air nozzle in the conveyance direction such that the difference in position in the radial direction detected by the position detecting device is closer to the preset range.

8. The sheet conveying device according to claim 6, further comprising:
a pulling device that is arranged at downstream of the second conveying portion in the conveyance direction and pulls the sheet such that a preset tension is applied,
wherein
the preset range is determined in accordance with the tension applied to the sheet.

9. A method for adjusting a sheet conveying device that includes a first conveying portion at which a band-like sheet including a first surface and a second surface on an opposite side of the first surface is conveyed with the first surface facing downward, a turn portion that includes a convex surface an axial line of which extends in a width direction of the sheet, is provided at downstream of the first conveying portion in a conveyance direction of the sheet, and turns the sheet along the convex surface with the first surface facing inside, a second conveying portion provided at downstream of the turn portion in the conveyance direction and at which the sheet is conveyed with the second surface facing downward, and an air jet device that includes an air nozzle that is provided at a boundary portion between the first conveying portion and the turn portion and extends in the width direction of the sheet and jets air from the air nozzle,
the convex surface including
a small-diameter portion that is opposed to a central portion of the sheet in the width direction, and
a pair of large-diameter portions that are arranged at both sides of the small-diameter portion in an axial direction, protrude outward from the small-diameter portion in a radial direction, and support both end portions of the sheet in the width direction,
the air nozzle being configured such that a width thereof in the conveyance direction can be adjusted,
the method comprising:
measuring a difference in position in the radial direction between the both end portions of the sheet in the width direction supported by the pair of large-diameter portions and the central portion of the sheet in the width direction; and
adjusting the width of the air nozzle in the conveyance direction such that the measured difference in position in the radial direction is in a preset range.

10. The method for adjusting a sheet conveying device according to claim 9, wherein
the sheet conveying device further includes a pulling device that is arranged at downstream of the second conveying portion and pulls the sheet, and
the preset range is determined in accordance with a tension applied to the sheet.

11. The method for adjusting a sheet conveying device according to claim 9, wherein
the air jet device includes a straightening plate that forms a portion of a wall surface of an air inlet port communicating with the air nozzle and is configured such that an angle of the straightening plate can be adjusted, and
the adjusting of the width of the air nozzle includes adjusting the angle of the straightening plate such that the measured difference in position in the radial direction is in a preset range.
